(19) United States
(12) Patent Application Publication
(10) Pub. No.: US 2026/0306889 A1
(43) Pub. Date: Oct. 8, 2026

(54) GRID-BASED STORAGE STRUCTURE WITH SPRINKLER SYSTEM

(71) Applicant: Nimble Robotics, Inc., San Francisco, CA (US)

(72) Inventors: Matthew Shekels, San Francisco, CA (US); Simon Kalouche, San Francisco, CA (US)

(73) Assignee: Nimble Robotics, Inc., San Francisco, CA (US)

(21) Appl. No.: 19/639,477

(22) Filed: Apr. 6, 2026

Related U.S. Application Data
(60) Provisional application No. 63/785,398, filed on Apr. 8, 2025.

(51) Int. Cl. A62C 35/68; B65G 1/04

(52) U.S. Cl. CPC A62C 35/68; B65G 1/0464; B65G 1/0478

(57) ABSTRACT

A grid-based storage structure having an integrated sprinkler system. The storage structure includes a framework having a plurality of vertical pillars, a first set of rails extending in a first direction and a second set of rails extending in a second direction substantially perpendicular to the first direction to form a grid defining a plurality of grid spaces. A plurality of bins configured to store inventory items are stacked on top of one another in stacks, each stack being arranged within a grid space. The sprinkler system includes one or more water supply channels at least partially disposed within the framework and a plurality of sprinkler heads arranged to supply water to the stacks to control and suppress the flames of a fire and protect the inventory items.

### CROSS-REFERENCE TO RELATED APPLICATIONS

This application claims the benefit of the filing date of United States Provisional Patent Application No. 63/785,398 filed Apr. 8, 2025, the disclosure of which is hereby incorporated herein by reference.

### TECHNICAL FIELD

The present disclosure relates to grid-based storage and retrieval systems that house inventory items in bin stacks, and more particularly, to a sprinkler system integrated within a grid-based storage structure designed to control and suppress the flames of a fire and protect the inventory items.

### BACKGROUND

Distribution fulfillment centers, such as warehouses, require systems that enable the efficient storage and retrieval of a large number of diverse products. Traditionally, inventory items are stored in containers, or bins, and arranged on rows of shelving on either side of an aisle. Each bin holds a plurality of items of one or more product types. The aisles provide access between the shelving for an operator or robot to migrate the aisles and retrieve the items. It is well understood that the aisles reduce the storage density of the system. In other words, the amount of space used for the storage of products (e.g., the shelving) is relatively small compared to the amount of space required for the storage system as a whole. As warehouse space is often scarce and expensive, alternative storage systems that maximize storage space are desired.

In one alternative approach, which offers a significant improvement in storage density, bins are stacked on top of one another and arranged in adjacent rows. That is, no aisle is provided between the adjacent rows of stacked bins. Thus, more bins, and in turn inventory, can be stored in a given space.

Various methods for retrieving inventory from the stacked bins have been contemplated. For example, U.S. Pat. Pub. No. 2021/0032034, which is incorporated by reference herein in its entirety, discloses a system in which bins are stacked and arranged in a plurality of rows underneath a grid. When an order is placed, the bins are retrieved by robots which subsequently pick and pack ordered inventory items into order bins. The robots disclosed in U.S. Pat. Pub. No. 2021/0032034, and other similar grid-based storage and retrieval systems, are powered by secondary batteries. Although rare, these secondary batteries can catch on fire. When this occurs, the fire can spread quickly throughout the storage structure and damage the stored inventory items resulting in millions of dollars of damage. To guard against such loses, warehouse operators may install sprinkler systems about a ceiling, or false ceiling, of the warehouse (e.g., well above the grid). However, these sprinkler systems are often costly to install and relatively ineffective as the sprinkler heads are incapable of directly targeting the bins.

### BRIEF SUMMARY OF THE DISCLOSURE

The grid-based storage structure disclosed herein has an integrated sprinkler system provided with sprinkler heads to control and suppress flames in the event of a fire. Utilizing the existing framework of grid-based storage system alleviates the need to outfit the warehouse with expensive and customized plumbing and related infrastructure. Additionally, the sprinkler heads may be positioned underneath the grid and oriented toward the stacks thereby improving the effectiveness of the sprinkler heads by increases the amount of water that is dispensed to the bins.

In one aspect, a storage structure, includes: a framework including a plurality of vertical pillars, a first set of rails extending in a first direction and a second set of rails extending in a second direction substantially perpendicular to the first direction, the first set of rails and the second set of rails forming a grid defining a plurality of grid spaces; a plurality of bins configured to store inventory items and arranged in stacks, each stack being arranged within a grid space; and sprinkler system including one or more water supply channels and a plurality of sprinkler heads, wherein the one or more water supply channels is at least partially disposed within the framework.

The one or more water supply channels may extend through one of the first set of rails or the second set of rails. The plurality of sprinkler heads may be at least partially disposed underneath the one of the first set of rails or the second set of rails and oriented to spray water downwards and towards the plurality of bins.

The storage structure may further include one or more pneumatic supply channels at least partially disposed within the one of the first set of rails or the second set of rails. The one or more water supply channels may be independent and discrete from the one or more pneumatic supply channels. For example, the one or more water supply channels is disposed below the one or more pneumatic supply channels. The one or more pneumatic supply channels may be disposed adjacent an upper surface of the one of the first set of rails or the second set of rails, the upper surface defining a track for a plurality of robots. The one or more water supply channels may be disposed adjacent a lower surface of the one of the first set of rails or the second set of rails, and the plurality of sprinkler heads is at least partially underneath the one of the first set of rails or the second set of rails. In another example, the one or more pneumatic supply channels may at least partially surround the one or more water supply channels.

In another aspect, a storage structure, includes: a framework including a plurality of vertical pillars, a first set of rails extending in a first direction and a second set of rails extending in a second direction substantially perpendicular to the first direction, the first set of rails and the second set of rails forming a grid defining a plurality of grid spaces; a plurality of bins configured to store inventory items and arranged in stacks, each stack being arranged within a grid space; and sprinkler system including one or more water supply channels and a plurality of sprinkler heads disposed at least partially underneath an upper surface of the grid and arranged to spray water toward the stacks.

The one or more water supply channels may be coupled to an outside of the framework. The one or more water supply channels may extend through one of the first set of rails or the second set of rails.

The storage structure may further include one or more pneumatic supply channels at least partially disposed within the one of the first set of rails or the second set of rails. The one or more water supply channels may be independent and discrete from the one or more pneumatic supply channels. The one or more water supply channels may be disposed below the one or more pneumatic supply channels. The one or more pneumatic supply channels may be disposed adjacent the upper surface of the grid defining a track for a plurality of robots, and wherein the one or more water supply channels is disposed adjacent a lower surface of the one of the first set of rails or the second set of rails. The one or more pneumatic supply channels may at least partially surround the one or more water supply channels.

In yet another aspect, a storage and retrieval system, includes a storage structure and a plurality of robots. The storage structure, includes: a framework including a plurality of vertical pillars, a first set of rails extending in a first direction and a second set of rails extending in a second direction substantially perpendicular to the first direction, the first set of rails and the second set of rails forming a grid defining a plurality of grid spaces; a plurality of bins configured to store inventory items and arranged in stacks, each stack being arranged within a grid space; and sprinkler system including one or more water supply channels and a plurality of sprinkler heads, wherein the one or more water supply channels is at least partially disposed within the first set of rails or the second set of rails. The plurality of robots is disposed on the grid, and at least one of the plurality of robots includes: a wheel assembly arranged to traverse the first set of rails and the second set of rails and a bin retrieval device for lifting one or more bins from the stacks.

The storage structure may further include a pneumatic supply channel at least partially disposed within the first set of rails or the second set of rails and one or more valves transitionable between an open position and a closed position. At least one of the plurality of robots further includes: a robotic picking arm having a pneumatically actuated end effector, and a pneumatic coupler having a mating end arranged to selectively engage the one or more valves to transition the one or more valves from the closed position to the open position to access pneumatics for operating the pneumatically actuated end effector.

### BRIEF DESCRIPTION OF THE DRAWINGS

FIG. 1 is a schematic perspective view of a grid-based storage structure having an integrated sprinkler system and housing a plurality of bins in stacks.

FIG. 2A is partial perspective of the grid-based storage structure of FIG. 1.

FIG. 2B is a side elevation view of the grid-based storage structure of FIG. 1.

FIG. 3 is a top elevation view of a single grid cell of the grid-based storage structure of FIG. 1.

FIG. 4A is an exploded view showing the grid including a supply rail of the grid-based storage structure of FIG. 1.

FIG. 4B is a perspective view of the supply rail of FIG. 4A.

FIG. 5 is a perspective view of a robot including a picking arm and a grapple arranged to operate on top of the grid-based storage structure of FIG. 1.

FIG. 6 is a cross-section view of a rail illustrating a water supply channel of the sprinkler system of FIG. 1 according to an embodiment of the present disclosure.

FIG. 7A is a cross-section view of a rail illustrating a water supply channel of the sprinkler system of according to another embodiment of the present disclosure.

FIG. 7B is a cross-section view of a rail and illustrating a water supply channel of the sprinkler system of according to yet another embodiment of the present disclosure.

### DETAILED DESCRIPTION

The technology disclosed herein relates to a grid-based storage structure having a sprinkler system integrated therein. As used herein, terms of orientation, for example, “vertical” and “horizontal,” or relative terms, such as “above,” “upwards,” “underneath,” and “downwards,” are used to describe the orientation or the relative position of objects in the normal gravitational frame of reference; that is, when the storage structure is resting on the warehouse floor. Also as used herein, the terms “substantially,” “generally,” and “about” are intended to mean that slight deviations from absolute are included within the scope of the term so modified.

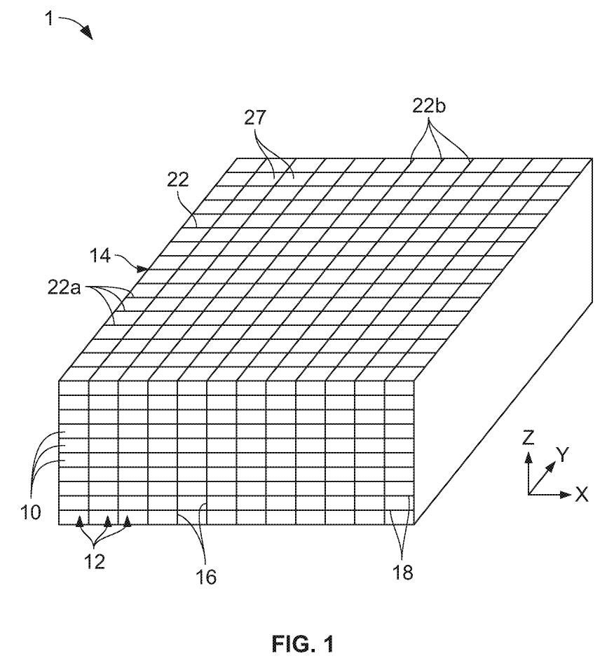

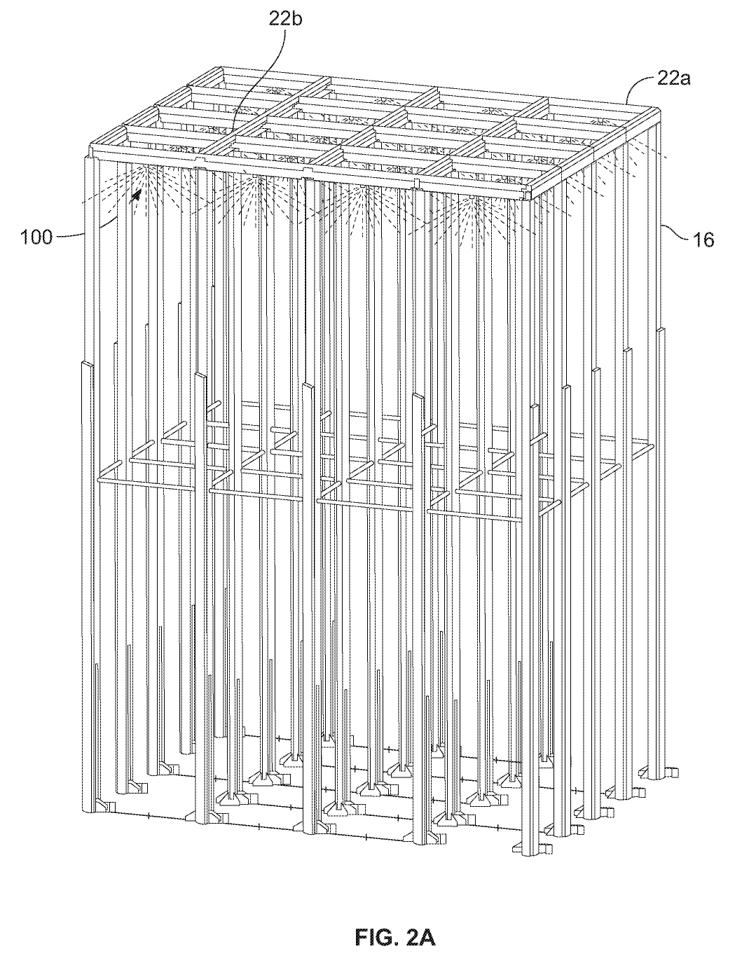

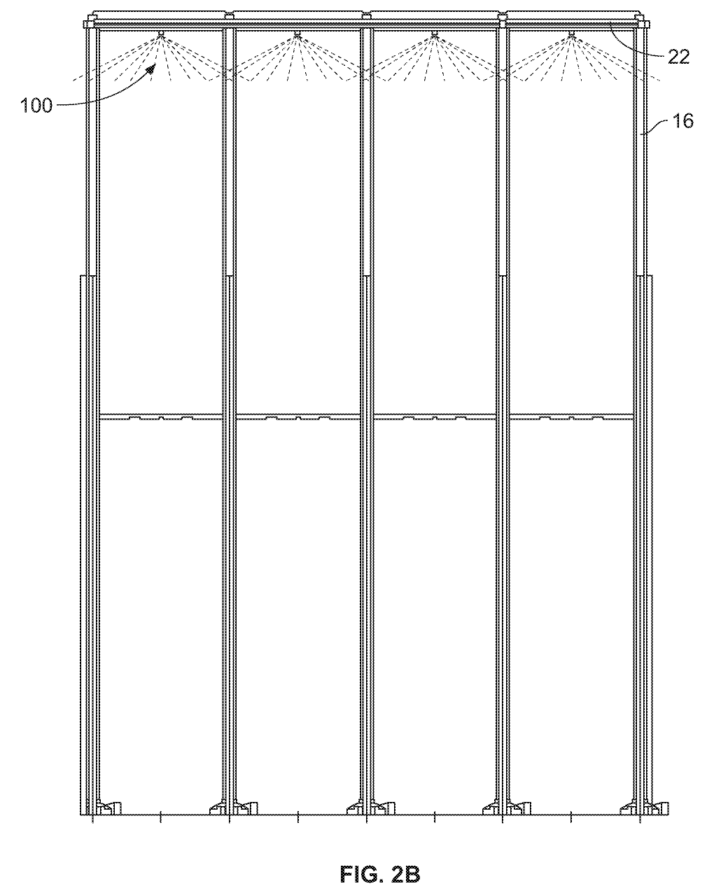

FIGS. 1-2B illustrate of a grid-based storage structure provided with a sprinkler system 100 according to an embodiment of the present disclosure. The storage structure includes a framework 14 and a plurality of bins 10 configured to store inventory items (not shown) of one or more product types. Bins 10 may have an open top through which the inventory items can be retrieved and preferably include cooperative nesting features that allow the bins to be stacked on top of one another to form stacks 12. Each of the stacks 12 are efficiently housed within framework 14.

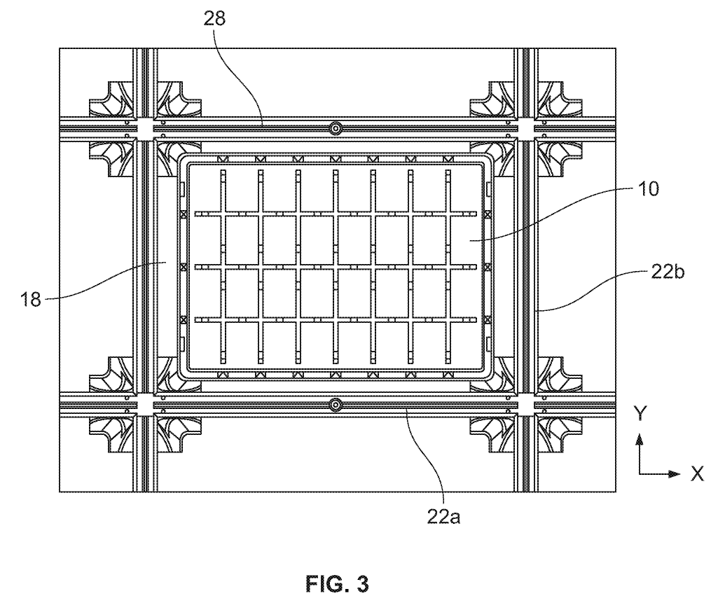

Framework 14 may include a plurality of vertical pillars 16 and a series of perpendicularly arranged rails 22 supported by the pillars at an uppermost level of the framework. More specifically, pillars 16 form vertical shafts within which stacks 12 are housed. Rails 22 include a first set of rails 22a extending in a first direction (e.g., x-direction) and a second set of rails 22b extending in a second direction (y-direction) perpendicular to the first direction. For this reason, rails 22 may collectively be referred to as a grid 26, and the footprint of each vertical shaft may be referred to as a grid-space 27 (or “a grid-cell”). FIG. 3 is a top-elevation view depicting a stack 12 housed within a single grid-cell 27.

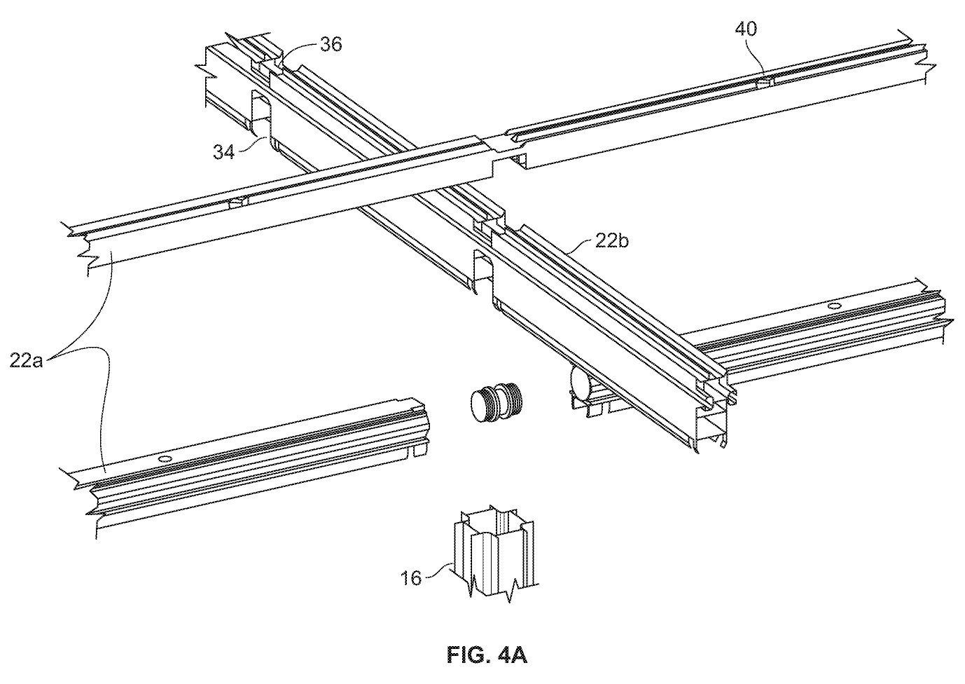

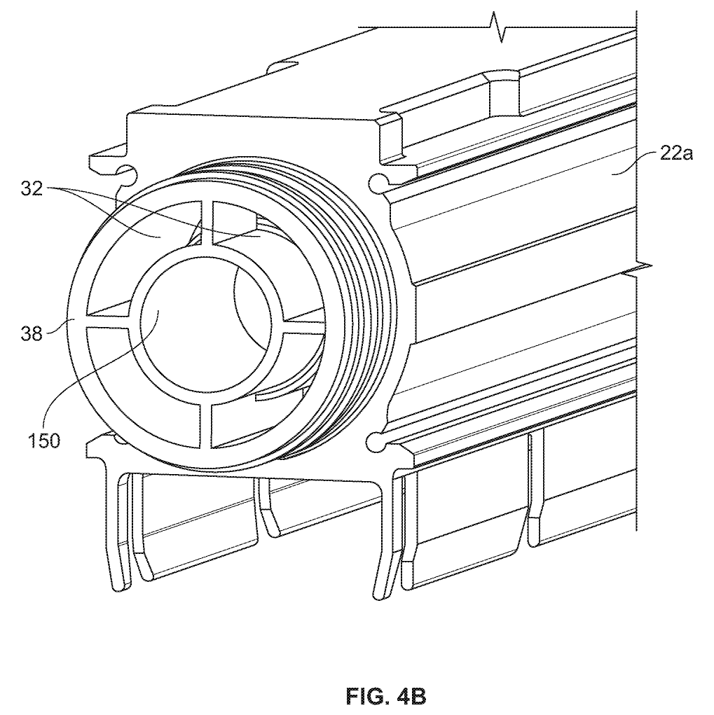

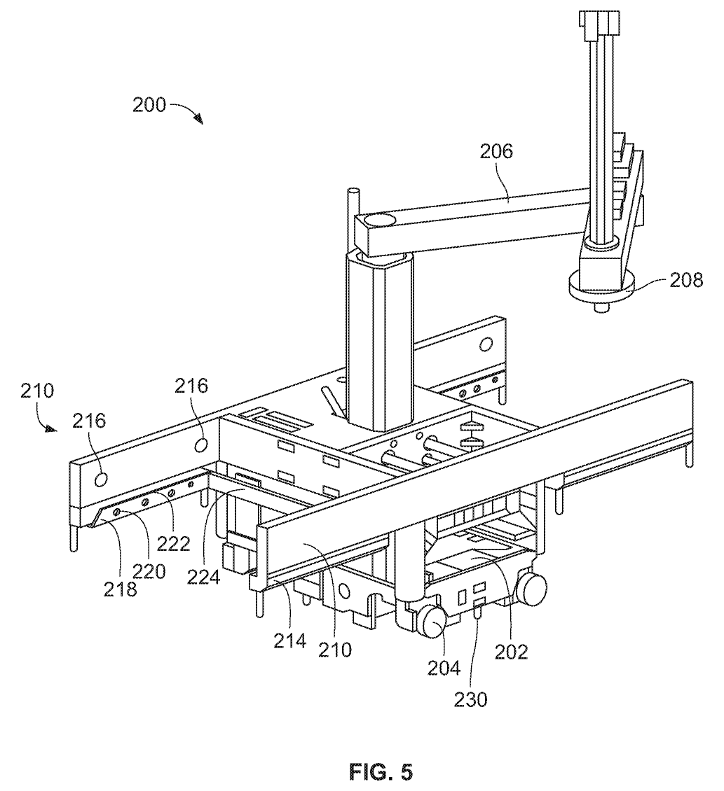

Rails 22 may be extruded or otherwise formed from a metal or metal alloy such as aluminum. As shown in FIGS. 3 and 4, an upper surface 28 of rails 22 may define a double u-shaped profiled track that acts as a drive surface to support and guide movement of robots 200 (FIG. 5) about grid 26 as the robots’ complete order fulfillment tasks. In this manner, two robots may traverse a single rail 22, increasing the number of robots capable of driving on grid 26 at any given time.

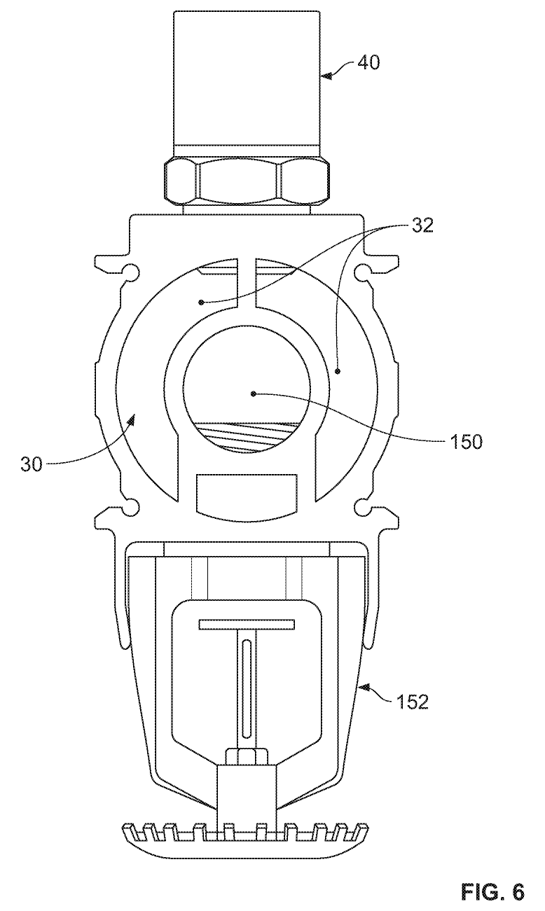

With additional reference to FIGS. 4A, 4B, and 6, framework 14 may define a pneumatic supply system 30 configured to supply pneumatics to robot 200 when the robot is installed on grid 26. Pneumatic supply system 30 thus eliminates the need for robot 200 to carry a bulky onboard air compressor, or vacuum generator, to operate its pneumatic end effector 208 and grasp inventory items stored in bins 10. As used herein, the term “onboard” means the component is housed within, or otherwise secured to robot 200, and carried by the robot as the robot traverses about grid 26.

Pneumatic supply system 30 may include a pneumatic supply channel 32 and a compressor (not shown) for supplying compressed air to the pneumatic supply channel. While pneumatic supply channel 32 is primarily described and illustrated herein as extending through rail 22a or rail 22b, it will be appreciated that the pneumatic supply channel may additionally, or alternatively, extend at least partially through pillars 16, be attached to an external surface of framework 14 (e.g., the rails and/or the pillars), or otherwise be in close proximity of the rails 22 so long as the pneumatic supply system 30 is accessible to robot 200 when the robot is positioned on grid 26.

As shown in FIG. 4A, rail 22b may be formed as a “spacer rail” defining a series of lower notches 34 designed to receive a “supply rail” and a series of upper notches 36 designed to receive a “top rail” defining the profiled track. The combination of the supply rail and the top rail forming the rail 22a. It will be appreciated that rail 22a and rail 22b may be interchanged such that rail 22a is the spacer rail and the combination of the supply rail and the top rail combine to form rail 22b.

A series of supply rails may be joined together via a connector 38 and, once joined, pneumatic supply channel 32 may extend along an entire length of the rail. In this regard, pneumatic supply channel 32 may be embedded within the supply rail so as to extend continuously in a longitudinal direction without interruption at the junctions of grid spaces 27.

A plurality of valves 40 may be disposed within the supply rail and in communication with pneumatic supply channel 32. Each valve 40 is designed to be transitioned between a closed position in which the pneumatics is contained within pneumatic supply system 30 and an open position in which the pneumatic supply channel 32 is in fluid communication with the environment such that pneumatics can be accessed and supplied to robot 200. As described in U.S. Pat. Pub. No. 2021/0032034, each valve 40 may include a biasing member, such as a spring, and a plug coupled to the spring to seal a port extending through an upper surface of the top rail. When the spring is in a neutral or unbiased condition, the spring biases the plug into the port, which seals the pneumatics within pneumatic supply channel 32. Alternative valves may be used for this purpose. For example, the valve may be constructed as any passively or actively actuated valve capable of being transitioned between a closed position and an open position, such as an electrohydraulic, electromechanical, or purely mechanical servo valve. In a preferred embodiment, a valve 40 is located within at least one rail defining each grid space 27 so that robot 200 can access the pneumatics irrespective of the robot’s location on grid 26.

Robot 200, as shown in FIG. 5, includes a communication interface to send and receive data between the robot and a remote computer, such as a Warehouse Management System (WMS), enabling the remote computer to control movement and operation of each of the robots about grid 26. Robot 200 includes a body 202 and a wheel assembly 204. In one embodiment, wheel assembly 204 may include a plurality of wheels, a motor, and one or more transmissions (belts or linkages) operably coupling each one of the wheels to the motor. The orientation of the wheels is controlled by the motor and the one or more transmissions. More specifically, the motor is coupled to each one of the wheels, via the one or more transmissions, such that rotation of the motor simultaneously pivots the orientation of each one of the wheels. In this regard, the wheels may be concurrently pivoted between a first orientation in which each of the wheels is aligned with the first set of rails 22a and a second orientation in which each of the wheels is aligned with the second set of rails 22b (e.g., 90 degrees). A drive mechanism is associated with wheel assembly 204 to rotate the wheels and move body 202 along the rails 22 in which the wheels are positioned.

The body 202 of robot 200 may also include a picking arm 206 equipped with an end effector 208 for picking and packing inventory items and/or one or more storage bin retrieval devices 210. Picking arm 206 may be movable in at least three dimensions to allow end effector 208 to pick inventory items from bin 10 and to pack the picked inventory items into an order bin. End effector 208 may be a pneumatically actuated end effector such as a suction cup.

Robot 200 may also include a pneumatic coupler 230 adapted to receive pneumatics, such as compressed air, from pneumatic supply system 30. Pneumatic coupler 230 may be attached to the body 202 of robot and extend downwardly in a manner that allows the pneumatic coupler to selectively engage and disengage with valve 40. Pneumatic coupler 230 may be a generally hollow tube provided with a tapered mating end to assist in aligning with pneumatic coupler 230 within the port of rail 22. The mating end of coupler 230 may include a mechanical device for transitioning valve 40 between the closed and open positions. For example, the device may be a mechanical member adapted to push the plug away from the port (e.g., further into the pneumatic supply channel 32), or any other device for electrically, magnetically, or mechanically transitioning valve 40 between the closed and open positions.

As shown in FIG. 5, robot 200 may also include two storage bin retrieval devices 210: a first storage bin retrieval device attached to a front of body 202 and a second storage bin retrieval device attached to a back of the body. However, it is contemplated that robot 200 may include zero, one, two, three or four storage bin retrieval devices 210 and that the storage bin retrieval devices may be attached to the sides of body 202 in any arrangement.

Each storage bin retrieval device 210 may include a pair of support arms 212 and a grapple 214 designed to extract storage bins 10 from framework 14 and/or secure order bins to the body 202 of robot 200. Grapple 214 may be suspended from support arms 212 by cables or a chain (not shown and collectively referred to hereinafter as “cables”) which are connected to a winding mechanism 216 such as a spool, hoist, or winch. The cables can thus be wound and unwound to adjust the height of grapple 214 with respect to the support arms in the z-direction.

Grapple 214 may include a three-sided grapple frame 218 and a bin securement device such as pivotable flaps 220. The three sides of grapple frame 218 may be formed by opposing grapple arms 222 and a connector 224. Grapple arms 222 and connector 224 collectively define an aperture. Each flap may be pivotable relative to a respective grapple arm 222 between a deployed condition in which the flap extends away from the grapple arm to which it is connected and into the aperture, and an undeployed condition in which the flap lies substantially flush against the grapple arm or is otherwise disposed within the footprint of the grapple arm. Movement of flaps 220 between the undeployed and deployed condition may be controlled by an actuator disposed within grapple 214 and configured to convert an electrical signal carried through the cables to motion of the flaps. When flaps 220 are in the undeployed condition, the aperture is larger than storage bin 10, allowing grapple 214 to be lowered into a gap 18, and around a stack 12 of the storage bins, before the flaps are deployed and brought into engagement with an engagement feature such as a rib on a side of the storage bin. In this manner, storage bin retrieval device 210 is arranged to extract one or more storage bins 10 in a single lift (e.g., the storage bin secured to grapple 214 and any storage bins stacked thereon).

Referring back to FIGS. 2A and 2B, sprinkler system 100 may include a water supply channel 150 and a plurality of sprinkler heads 152. The water supply channel 150 may be in fluid communication with the plumbing of a warehouse to supply water in the event of a fire. As described hereinafter, sprinkler system 100 utilizes the existing infrastructure (e.g., framework 14) rather than separate, custom plumbing, and therefore, provides a simpler, lower cost, and more effective result. While water supply channel 150 is primarily described and illustrated herein as extending through rail 22a or rail 22b, it will be appreciated that the water supply channel may additionally, or alternatively, extend at least partially through pillars 16, be attached to an external surface of framework 14 (e.g., an underside of the rails and/or the pillars), or otherwise be in close proximity of the rails 22 so long as the sprinkler heads 152 are capable of supplying water within the grid-based storage structure and to the stacks 12 of bins 10 to protect the inventory.

Referring to FIG. 6, water supply channel 150 may extend through the supply rail (e.g., the same rail having pneumatic supply channel 32) and be independent and discrete of the pneumatic supply channel. For example, water supply channel 150 may extend along a longitudinal length of the supply rail and be in fluid communication with a sprinkler head 152 disposed underneath the supply rail. The sprinkler heads 152 are preferably located underneath grid 26 and/or oriented towards the stacks 12 of bins 10 to suppress flames in the event of a fire. The sprinkler heads 152 are preferably located directly underneath rails 22 or at another location that will not interfere with the extension and retraction of the grapple 214 of robot 200.

The pneumatic supply channel 32, as shown in FIG. 6, may extend at least partially around the water supply channel 150 and be disposed adjacent the upper surface of the supply rail (e.g., rail 22a) near valve 40. In one example, pneumatic supply channel 32 may be concentrically disposed at least partially about water supply channel 150. In this regard, pneumatic supply channel 32 may serve as an air insulator and preserve the structural integrity of the water supply channel 150 during a fire.

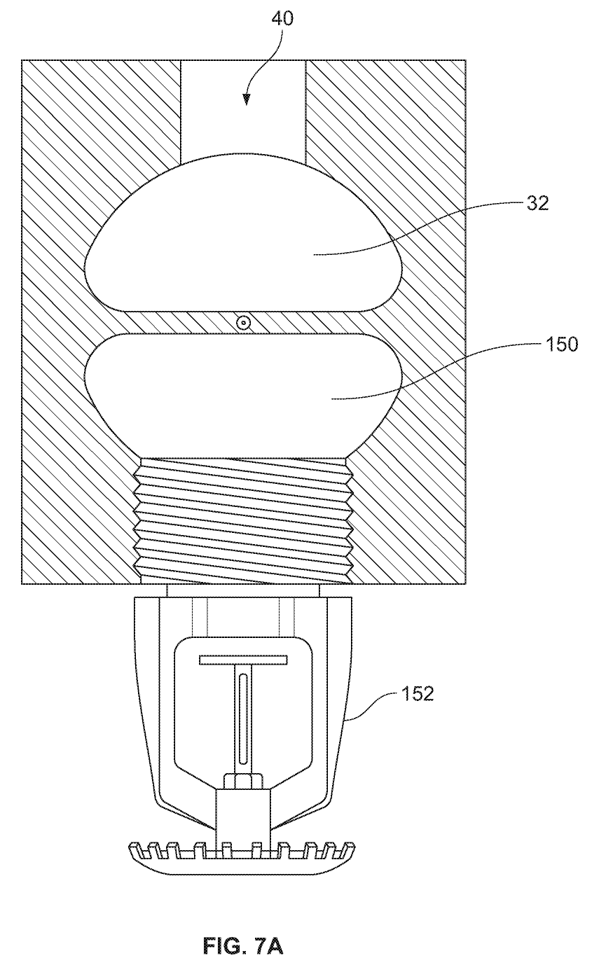

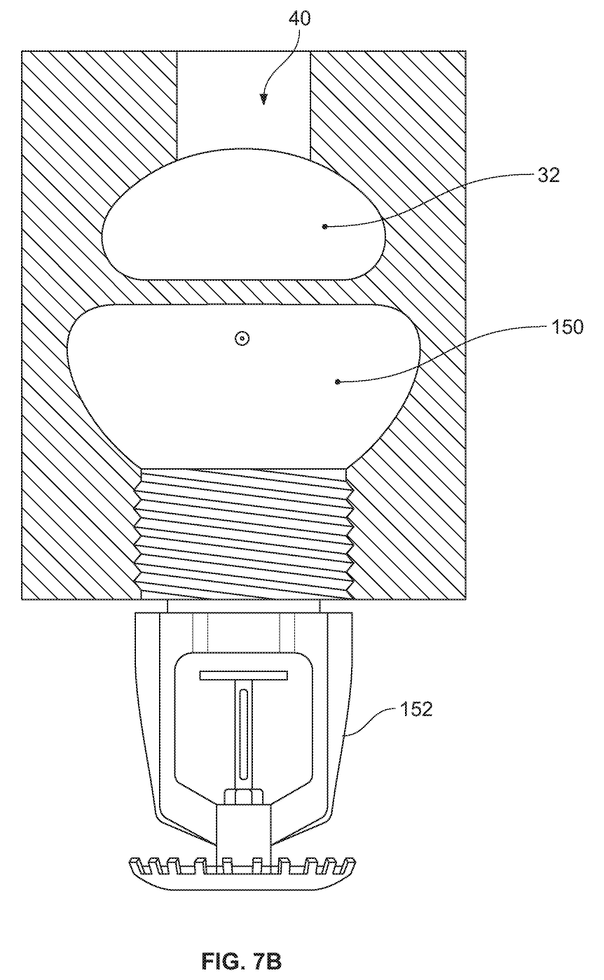

FIGS. 7A and 7B illustrate alternative embodiments of the supply rail. As shown in FIG. 7A, pneumatic supply channel 32 and water supply channel 150 may be formed as half-circles having the same size and situated on opposite side of the midline of the supply rail. Pneumatic supply channel 32 may be disposed above the water supply channel 150 and adjacent to valve 40. Put differently, water supply channel 150 may be disposed underneath pneumatic supply channel 32 and adjacent a lower end of the supply rail near sprinkler head 152. FIG. 7B illustrates an alternative embodiment, in which the water supply channel 32 is larger than the pneumatic supply channel 32 such that the water supply channel consumes more than half of the interior of the supply rail. The pneumatic supply channel 32 and the water supply channel 150 may be differently shaped and sized to provide the desired pneumatic pressure for the end effector 208 of robot 200 and the water pressure to control a fire within the storage structure. It is understood that the channels can be arranged in size or shape. The described and illustrated embodiments (e.g., circular, ovular, half circles, etc.) are merely exemplary methods of two independent and discrete channels within the frame. In embodiments in which the supply rail includes both a pneumatic supply channel 32 and a water supply channel 150, connector 38 may be designed to match the shape and size of the pneumatic supply channel and the water supply channel as shown in FIG. 4B. In this regard, connector 38 connects the supply rail segments and also creates a sealed interface between the respective channels along the supply rail extending from one side of grid 26 to an opposite side of the grid.

Sprinkler head 152 may be formed as a traditional sprinkler head, a water cannon, a hose, or any other device designed to dispense water. In one example, sprinkler heads 152 may be disposed underneath each valve 40. However, more or less sprinkler heads 152 may be utilized. In some examples, sprinkler heads 152 may contain a heat-sensitive liquid contained within a glass such that when the liquid is heated, the liquid will expand to break to the glass and release water from the water supply channel 150 to suppress the fire. In another scenarios, robot 200 may activate one or more sprinkler heads 152 via a mechanical or electromechanical actuation. In another scenario, sprinkler heads 152 may be wirelessly activated by a robot 200 or a processor associated with the warehouse.

It will be appreciated that sprinkler system 100 may be integrated into other grid-based systems that do not include pneumatic supply system 30. Put differently, the supply rail may include water supply channel 150 without pneumatic supply channel 32.

Although the disclosure herein has been described with reference to particular embodiments, it is to be understood that these embodiments are merely illustrative of the principles and applications of the present disclosure. It is therefore to be understood that numerous modifications may be made to the illustrative embodiments and that other arrangements may be devised without departing from the spirit and scope of the present disclosure as defined by the appended claims.

1. A storage structure, comprising:
a framework including a plurality of vertical pillars, a first set of rails extending in a first direction and a second set of rails extending in a second direction substantially perpendicular to the first direction, the first set of rails and the second set of rails forming a grid defining a plurality of grid spaces;
a plurality of bins configured to store inventory items and arranged in stacks, each stack being arranged within a grid space; and
sprinkler system including one or more water supply channels and a plurality of sprinkler heads, wherein the one or more water supply channels is at least partially disposed within the framework.

2. The storage structure of claim 1, wherein the one or more water supply channels extends through one of the first set of rails or the second set of rails.

3. The storage structure of claim 2, wherein the plurality of sprinkler heads is at least partially disposed underneath the one of the first set of rails or the second set of rails and oriented to spray water downwards and towards the plurality of bins.

4. The storage structure of claim 1, further comprising one or more pneumatic supply channels at least partially disposed within the one of the first set of rails or the second set of rails.

5. The storage structure of claim 4, wherein the one or more water supply channels is independent and discrete from the one or more pneumatic supply channels.

6. The storage structure of claim 5, wherein the one or more water supply channels is disposed below the one or more pneumatic supply channels.

7. The storage structure of claim 5, wherein the one or more pneumatic supply channels is disposed adjacent an upper surface of the one of the first set of rails or the second set of rails, the upper surface defining a track for a plurality of robots.

8. The storage structure of claim 7, wherein the one or more water supply channels is disposed adjacent a lower surface of the one of the first set of rails or the second set of rails, and the plurality of sprinkler heads is at least partially underneath the one of the first set of rails or the second set of rails.

9. The storage structure of claim 5, wherein the one or more pneumatic supply channels at least partially surrounds the one or more water supply channels.

10. A storage structure, comprising:
a framework including a plurality of vertical pillars, a first set of rails extending in a first direction and a second set of rails extending in a second direction substantially perpendicular to the first direction, the first set of rails and the second set of rails forming a grid defining a plurality of grid spaces;
a plurality of bins configured to store inventory items and arranged in stacks, each stack being arranged within a grid space; and
sprinkler system including one or more water supply channels and a plurality of sprinkler heads disposed at least partially underneath an upper surface of the grid and arranged to spray water toward the stacks.

11. The storage structure of claim 10, wherein the one or more water supply channels is coupled to an outside of the framework.

12. The storage structure of claim 10, wherein the one or more water supply channels extends through one of the first set of rails or the second set of rails.

13. The storage structure of claim 10, further comprising one or more pneumatic supply channels at least partially disposed within the one of the first set of rails or the second set of rails.

14. The storage structure of claim 13, wherein the one or more water supply channels is independent and discrete from the one or more pneumatic supply channels.

15. The storage structure of claim 14, wherein the one or more water supply channels is disposed below the one or more pneumatic supply channels.

16. The storage structure of claim 14, wherein the one or more pneumatic supply channels is disposed adjacent the upper surface of the grid defining a track for a plurality of robots, and wherein the one or more water supply channels is disposed adjacent a lower surface of the one of the first set of rails or the second set of rails.

17. The storage structure of claim 14, wherein the one or more pneumatic supply channels at least partially surrounds the one or more water supply channels.

18. A storage and retrieval system, comprising:
a storage structure, including:
a framework including a plurality of vertical pillars, a first set of rails extending in a first direction and a second set of rails extending in a second direction substantially perpendicular to the first direction, the first set of rails and the second set of rails forming a grid defining a plurality of grid spaces;
a plurality of bins configured to store inventory items and arranged in stacks, each stack being arranged within a grid space; and
sprinkler system including one or more water supply channels and a plurality of sprinkler heads, wherein the one or more water supply channels is at least partially disposed within the first set of rails or the second set of rails; and
a plurality of robots disposed on the grid, at least one of the plurality of robots including:
a wheel assembly arranged to traverse the first set of rails and the second set of rails; and
a bin retrieval device for lifting one or more bins from the stacks.

19. The storage and retrieval system of claim 18, wherein the storage structure further comprises a pneumatic supply channel at least partially disposed within the first set of rails or the second set of rails and one or more valves transitionable between an open position and a closed position.

20. The storage and retrieval system of claim 19, wherein at least one of the plurality of robots further comprises:
a robotic picking arm having a pneumatically actuated end effector; and
a pneumatic coupler having a mating end arranged to selectively engage the one or more valves to transition the one or more valves from the closed position to the open position to access pneumatics for operating the pneumatically actuated end effector.
